(19) United States
(12) Patent Application Publication
(10) Pub. No.: US 2017/0077754 A1
(43) Pub. Date: Mar. 16, 2017

(54) NEAR FIELD COMMUNICATION AND WIRELESS POWER TRANSFER DUAL MODE ANTENNAS FOR METAL BACKED DEVICES

(71) Applicant: QUALCOMM Incorporated, San Diego, CA (US)

(72) Inventors: Seong Heon Jeong, San Diego, CA (US); Paul Brandon Butler, San Jose, CA (US); Mahbod Mofidi, San Diego, CA (US); Francesco Carobolante, San Diego, CA (US)

(21) Appl. No.: 15/085,177

(22) Filed: Mar. 30, 2016

Related U.S. Application Data
(60) Provisional application No. 62/219,017, filed on Sep. 15, 2015.

(51) Int. Cl. H02J 50/12; H04B 5/00; H01F 41/06; H02J 7/02; H01F 38/14

(52) U.S. Cl. CPC H02J 50/12; H02J 7/025; H01F 38/14; H01F 41/06; H04B 5/0093; H04B 5/0037

(57) ABSTRACT

In one aspect, an apparatus for wirelessly coupling with other devices is provided. The apparatus includes a metallic cover having a removed portion. The apparatus comprises a first coil substantially wound around the removed portion of the metallic cover and configured to communicate with at least one other device via a communications protocol. The metallic cover comprises a second coil substantially wound around the removed portion of the metallic cover and configured to wirelessly and inductively receive charging power sufficient to charge or power the apparatus from at least one wireless charging power transmitter.

### CLAIM OF PRIORITY UNDER 35 U.S.C. §119

The present application for patent claims priority to Provisional Application No. 62/219,017 entitled “NEAR FIELD COMMUNICATION AND WIRELESS POWER TRANSFER DUAL MODE ANTENNAS FOR METAL BACKED DEVICES” filed Sep. 15, 2015, and assigned to the assignee hereof. Provisional Application No. 62/219,017 is hereby expressly incorporated by reference herein.

### FIELD

Certain aspects of the present disclosure generally relate to metal backed devices, and more particularly, to near field communication (NFC) and Wireless Power Transfer Dual-Mode antennas for metal backed devices.

### BACKGROUND

Designs for mobile communication devices may include a metal back cover. Wireless power charging systems may provide the ability to charge and/or power electronic devices without physical, electrical connections, thus reducing the number of components required for operation of the electronic devices and simplifying the use of the electronic device. It is desirable to incorporate wireless power circuitry and NFC dual mode antennas into metal backed devices.

### SUMMARY

One aspect of the disclosure provides an apparatus for wirelessly coupling with other devices. The apparatus includes a metallic cover having a removed portion. The apparatus comprises a first coil substantially wound around the removed portion of the metallic cover and configured to communicate with at least one other device via a communications protocol. The metallic cover comprises a second coil substantially wound around the removed portion of the metallic cover and configured to wirelessly and inductively receive charging power sufficient to charge or power the apparatus from at least one wireless charging power transmitter.

Another aspect of the disclosure provides a method for wirelessly coupling an electronic device with other devices. The method includes communicating with at least one other device using a first coil substantially wound around a removed portion of a metallic cover of the electronic device via a communications protocol. The method includes wirelessly and inductively receiving power sufficient to charge or power the electronic device from at least one wireless charging power transmitter using a second coil substantially wound around the removed portion of the metallic cover.

Another aspect of the disclosure provides a method for manufacturing an electronic device for wirelessly coupling with other devices. The method comprises providing a metallic cover having a removed portion. The method comprises winding a first coil on the metallic cover substantially around the removed portion, the first coil configured to communicate with at least one other device via a communications protocol. The method comprises winding a second coil on the metallic cover substantially around the removed portion, the second coil configured to wirelessly and inductively receive charging power sufficient to charge or power the electronic device from at least one wireless charging power transmitter.

Another aspect of the disclosure provides an apparatus for wirelessly coupling with other devices. The apparatus includes a metallic cover comprising a removed portion. The apparatus includes means for communicating with at least one other device via a communications protocol, the means for communicating substantially wound around the removed portion of the metallic cover. The apparatus includes means for wirelessly and inductively receiving power sufficient to charge or power the apparatus from at least one wireless charging power transmitter, the means for wirelessly receiving power substantially wound around the removed portion of the metallic cover.

### BRIEF DESCRIPTION OF THE DRAWINGS

FIG. 1 is a functional block diagram of a wireless power transfer system, in accordance with an exemplary implementation.

FIG. 2 is a functional block diagram of a wireless power transfer system, in accordance with another exemplary implementation.

FIG. 3 is a schematic diagram of a portion of the transmit circuit or the receive circuit of FIG. 2 including a transmit coupler or a receive coupler, in accordance with an exemplary implementation.

FIG. 4 illustrates a top view of a metallic cover for an electronic device, in accordance with some implementations.

FIG. 5 illustrates a top view of another metallic cover for an electronic device, in accordance with some implementations.

FIG. 6 is a schematic diagram showing switching circuitry between the first coil and the second coil of FIG. 5.

FIG. 7 illustrates a top view of another metallic cover for an electronic device, in accordance with some implementations.

FIG. 8 illustrates a top view of another metallic cover for an electronic device, in accordance with some implementations.

FIG. 9 is a flow chart for a method for wirelessly coupling an electronic device with other devices, in accordance with some implementations.

FIG. 10 is a flow chart for a method for manufacturing an electronic device for wirelessly coupling with other devices, in accordance with some implementations.

### DETAILED DESCRIPTION

Various aspects of the novel systems, apparatuses, and methods are described more fully hereinafter with reference to the accompanying drawings. The teachings of this disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, access networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

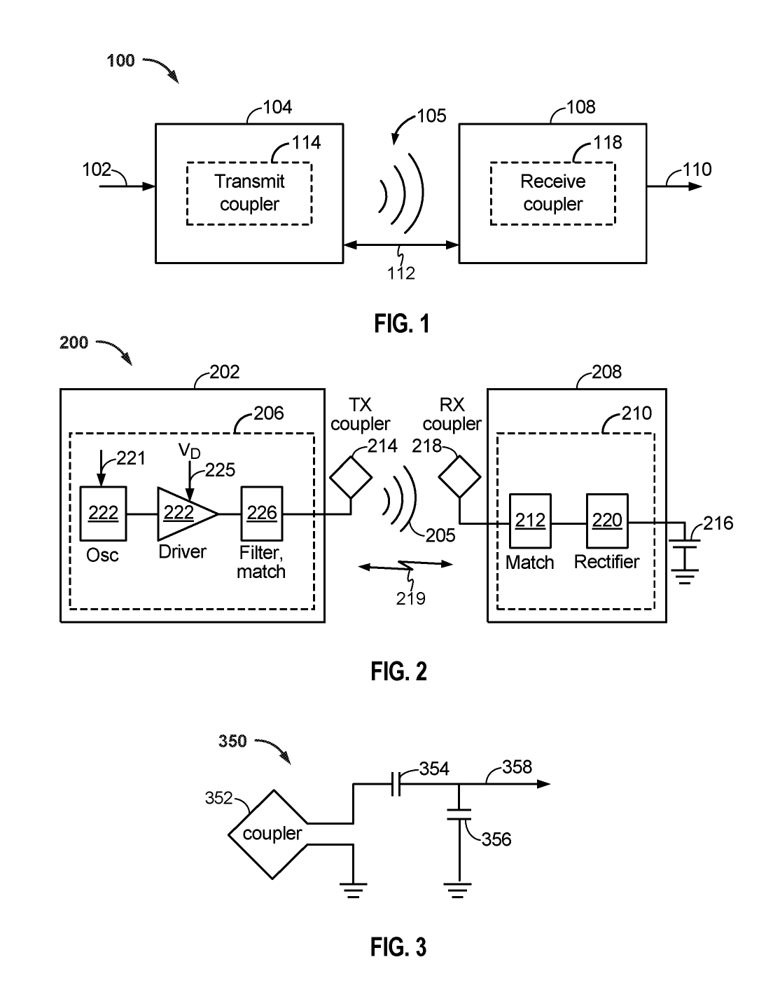

FIG. 1 is a functional block diagram of a wireless power transfer system 100, in accordance with an exemplary implementation. Input power 102 may be provided to a transmit coupler 114 of a transmitter 104 from a power source (not shown) to generate a wireless (e.g., magnetic or electromagnetic) field 105 for performing energy or power transfer. The wireless field 105 corresponds to a region where energy output by the transmitter 104 may be captured by a receiver 108. A receive coupler 118 (e.g., a receive coupler 118) of the receiver 108 may couple to the wireless field 105 and may generate output power 110 for storing or consumption by a device (not shown) coupled to the output power 110. Both the transmitter 104 and the receiver 108 may be separated by a distance 112.

In one exemplary implementation, power is transferred inductively via a time-varying magnetic field generated by the transmit coupler 114. The transmit coupler 114 and the receive coupler 118 may be configured according to a mutual resonant relationship. When the resonant frequency of the receive coupler 118 and the resonant frequency of the transmit coupler 114 are substantially the same, or very close, transmission losses between the transmitter 104 and the receiver 108 are minimal. Resonant inductive coupling techniques may thus allow for improved efficiency and power transfer over various distances and with a variety of coupler configurations.

In some implementations, the wireless field 105 corresponds to the “near-field” of the transmitter 104. The “near-field” may correspond to a region in which there are strong reactive fields resulting from the currents and charges in the transmit coupler 114 that minimally radiate power away from the transmit coupler 114, rather than radiating electromagnetic energy away into free space. The “near-field” may correspond to a region that is within about one wavelength (or a fraction thereof) of the transmit coupler 114.

Efficient energy transfer may occur by coupling a large portion of the energy in the wireless field 105 to the receive coupler 118 rather than propagating most of the energy in an electromagnetic wave to the far field. When positioned within the wireless field 105, a “coupling mode” may be developed between the transmit coupler 114 and the receive coupler 118.

FIG. 2 is a functional block diagram of a wireless power transfer system 200, in accordance with some other exemplary implementation. The system 200 includes a transmitter 204 and a receiver 208. The transmitter 204 includes transmit circuitry 206 that includes an driver circuit 224, a driver circuit 224, and a filter and matching circuit 226. The driver circuit 224 is configured to generate a signal at a desired frequency that may be adjusted in response to a frequency control signal 221. The driver circuit 224 provides the oscillator signal to the driver circuit 222. The driver circuit 222 is configured to drive the transmit coupler 214 at, for example, a resonant frequency of the transmit coupler 218 based on an input voltage signal (V_{D}) 225. The filter and matching circuit 226 filters out harmonics or other unwanted frequencies and may also match the impedance of the transmit circuitry 206 to the impedance of the transmit coupler 214 for maximal power transfer. The driver circuit 224 drives a current through the transmit coupler 214 to generate a wireless field 205 for wirelessly outputting power at a level sufficient for charging a battery 216.

The receiver 208 comprises receive circuitry 210 that includes a matching circuit 212 and a rectifier circuit 220. The matching circuit 212 may match the impedance of the receive circuitry 210 to the impedance of the receive coupler 218. The rectifier circuit 220 may generate a direct current (DC) power output from an alternate current (AC) power input to charge the battery 216. The receiver 208 and the transmitter 204 may additionally communicate on a separate communication channel 219 (e.g., NFC, Bluetooth, Zigbee, cellular, etc). The receiver 208 and the transmitter 204 may alternatively communicate via band signaling using characteristics of the wireless field 205. The receiver 208 may be configured to determine whether an amount of power transmitted by the transmitter 204 and received by the receiver 208 is appropriate for charging the battery 216.

FIG. 3 is a schematic diagram of a portion of the transmit circuitry 206 or the receive circuitry 210 of FIG. 2, in accordance with some exemplary implementations. As illustrated in FIG. 3, transmit or receive circuitry 350 may include a coupler 352. The coupler 352 may also be referred to or be configured as a “conductor loop”, a coil, an inductor, an antenna, or as a “magnetic” coupler. The term “coupler” generally refers to a component that may wirelessly output or receive energy for coupling to another “coupler.”

The resonant frequency of the loop or magnetic couplers is based on the inductance and capacitance of the loop or magnetic coupler. Inductance may be simply the inductance created by the coupler 352, whereas, capacitance may be added via a capacitor (or the self-capacitance of the coupler 352) to create a resonant structure at a desired resonant frequency. As a non-limiting example, a capacitor 354 and a capacitor 356 may be added to the transmit or receive circuitry 350 to create a resonant circuit that resonates at a resonant frequency. For larger sized couplers using large diameter coils exhibiting larger inductance, the value of capacitance needed to produce resonance may be lower. Furthermore, as the size of the coupler increases, coupling efficiency may increase. This is mainly true if the size of both base and electric vehicle couplers increase. For transmit couplers, the signal 358, with a frequency that substantially corresponds to the resonant frequency of the coupler 352, may be an input to the coupler 352. For receive couplers, the signal 358 may be the output from the coupler 352.

Designs for mobile communication devices may include a metal back cover. Current designs make it challenging to integrate both a wireless power coupler and a communications antenna on the same metal back cover, due to their different tuning and operating requirements. In addition, wireless power antennas disposed on metal backed devices pose particular challenges related to eddy current generation, heating and detuning caused by loading of the antennas by the induced eddy currents. The present disclosure is related to implementations for integrating a receive coil (e.g., coupler 352) and one or more communication antennas (e.g., an NFC antenna) into a design for a mobile communication device with a metal back cover. Implementations may include but are not limited to a single shared antenna using either the same coil but different feed locations, or separate yet connected coils having different feed locations. In other implementations, two separate antennas may have interleaved coils and independent feeds, or alternatively, the two coils may not be interleaved but rotated with respect to one another.

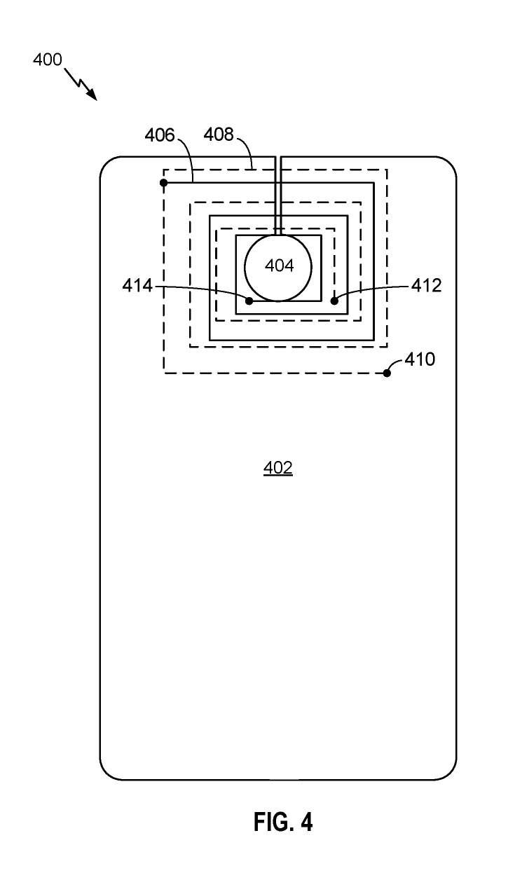

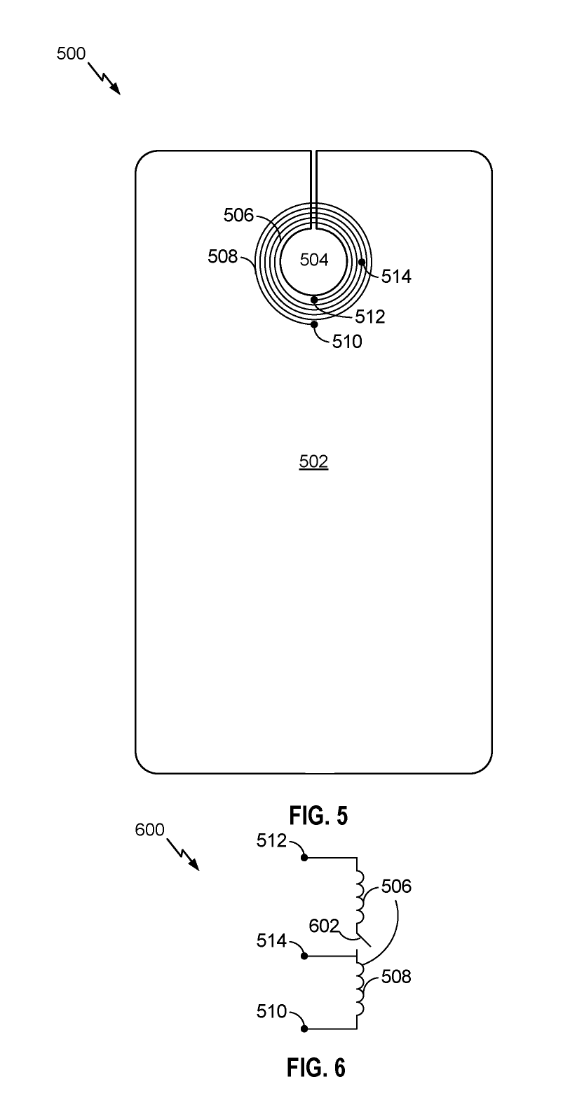

FIG. 4 illustrates a top view 400 of a metallic cover 402 for an electronic device, in accordance with some implementations. While certain implementations described herein may refer to a “metallic” cover 402, it is noted that in some implementations the cover 402 may be made from other materials, including other electrically conductive materials, in accordance with the principles of the various implementations described herein. The metallic cover 402 is shown as having a removed portion 404, which may be a camera lens opening or any other gap. The metallic cover 402 is also shown having a first coil 406 and a second coil 408. The first coil 406 is substantially wound around the removed portion 404 of the metallic cover 402. The second coil 408 is also substantially wound around the removed portion 404 of the metallic cover 402. In some implementations where the first coil 406 and the second coil 408 operate at a lower Q factor, the first coil 406 and the second coil 408 may be disposed such that the innermost windings of the first coil 406 and/or the second coil 408 are approximately 3 mm to 10 mm from the removed portion 404. Such implementations may equally apply to arrangements shown in FIGS. 5-8. In some implementations, the first coil 406 and/or the second coil 408 may be substantially centered around the removed portion 404 of the metallic cover 402. The second coil 408 and the first coil 406 may share a common port 410. The first coil 406 may be electrically connected to the second coil 408 at some point along the length of the first coil. The second coil 408 may have a second port 412 and the first coil 406 may have a first port 414. The first port 414 and the second port 412 may be different from one another. In some implementations, the portions of the second coil 408 and the first coil 406 that are separate from one another may be wound in an interleaved fashion. In some implementations, the traces of one of the second coil 408 and the first coil 406 may be longer than the other. The second port 412 and the common port 410 may be selectively connected to a first circuitry (not shown) (e.g., a wireless power receive circuitry for a wireless power receive coil or a communication circuitry for a communications coil). Likewise, the first port 414 and the common port 410 may be selectively connected to a second circuitry (not shown) (e.g., a communication circuitry for a communications coil or a wireless power receive circuitry for a wireless power receive coil). In some implementations, when the second coil 408 and its associated first circuitry are active, the first coil 406 and/or the first port 414 may be selectively electrically disconnected from the second circuitry via a switch (not shown). Contrarily, when the first coil 406 and its associated second circuitry are active, the second coil 408 and/or the second port 412 may be selectively electrically disconnected from the first circuitry. This provides at least the following benefits: one of the first and second circuitries are not loaded by the other of the first and second circuitries when not in use, and at least a portion of the second coil 408 may be reused by the first coil 406.

FIG. 5 illustrates a top view 500 of another metallic cover 502 for an electronic device, in accordance with some implementations. The metallic cover 502 is shown as having a removed portion 504, which may be a camera lens port or any other gap. The metallic cover 502 is also shown having a first coil 506 and a second coil 508. The first coil 506 is substantially wound around the removed portion 504 of the metallic cover 502. The second coil 508 is also substantially wound around the removed portion 504 of the metallic cover 502. The first coil 506 and the second coil 508 may share a common port 510. The first coil 506 may comprise the entire length of the trace of the second coil 508 as well as additional trace length that is not common to the first coil 506 and the second coil 508. Thus, in some implementations, the first coil 506 and the second coil 508 may comprise a single coil, however, having different ports located at different positions along the traces of the single coil. The first coil 506 may have a first port 512 and the second coil 508 may have a second port 514. The first port 512 and the second port 514 may be different from one another. The first port 512 and the common port 510 may be selectively connected to a first circuitry (not shown) (e.g., a wireless power receive circuitry for a wireless power receive coil or a communication circuitry for a communications coil). Likewise, the second port 514 and the common port 510 may be selectively connected to a second circuitry (not shown) (e.g., a communication circuitry for a communications coil or a wireless power receive circuitry for a wireless power receive coil).

In some other implementations, the port 514 may be the common port and the first coil 506 may have a first port 512 and the second coil 508 may have a second port 510. In such implementations, the first coil 506 and the second coil 508 may still comprise a single coil. However, in such an implementation, traces utilized for the first coil 506 and traces utilized for the second coil 508 are mutually exclusive of one another (e.g., portions of the conductor that forms the first coil 506 do not in any way also form any portion of the second coil 508 and vice versa.

FIG. 6 is a schematic diagram 600 showing a switching circuitry 602 between the first coil 506 and the second coil 508 of FIG. 5. In some implementations, when the first coil 506 and its associated first circuitry are active, a switching circuitry 602 may be closed, connecting the uncommon portion of the first coil (e.g., the portion between the port 512 and the port 514) to the second coil 508 (e.g., the portion between the port 510 and 512). Contrarily, when the second coil 508 and its associated second circuitry are active, the switching circuitry 602 is open, selectively disconnecting the uncommon portion of first coil from the second coil 508. This provides at least the benefit that at least a portion of the second coil 508 may be reused by the first coil 506.

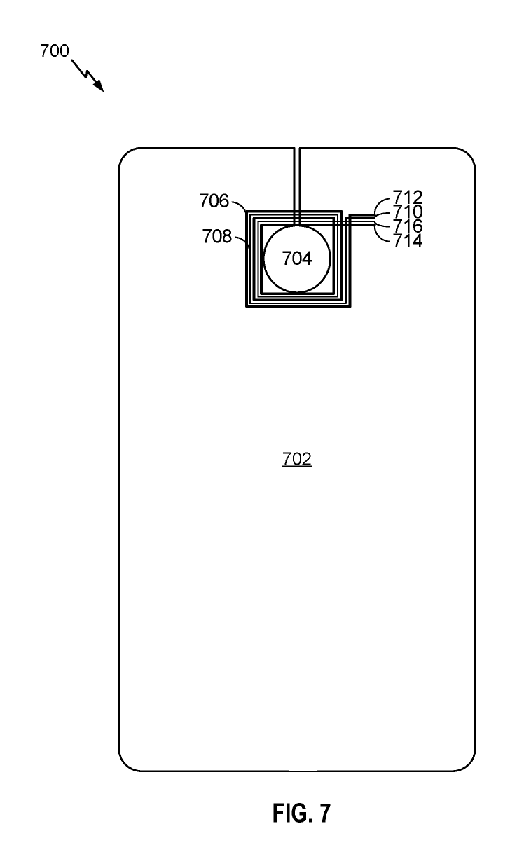

FIG. 7 illustrates a top view 700 of another metallic cover 702 for an electronic device, in accordance with some implementations. The metallic cover 702 is shown as having a removed portion 704, which may be a camera lens opening or any other gap. The metallic cover 702 is also shown having a first coil 706 and a second coil 708. The first coil 706 is substantially wound around the removed portion 704 of the metallic cover 702. The second coil 708 is also substantially wound around the removed portion 704 of the metallic cover 702. The first coil 706 and the second coil 708 are interleaved with one another and do not share a common port. Instead the first coil 706 has a first port 712 and a second port 714. Likewise, the second coil 708 has a third port 716 and a fourth port 710. The first coil 706 and the second coil 708 may be implemented on the same plane or on different planes. The first port 712 and the second port 714 may be selectively connected to a first circuitry (not shown) (e.g., a wireless power receive circuitry for a wireless power receive coil or a communication circuitry for a communications coil). Likewise, the third port 716 and the fourth port 710 may be selectively connected to a second circuitry (not shown) (e.g., a communication circuitry for a communications coil or a wireless power receive circuitry for a wireless power receive coil). In some implementations, when the first coil 706 and its associated first circuitry are active, the second coil 708 may be selectively electrically disconnected from the second circuitry. Contrarily, when the second coil 708 and its associated second circuitry are active, the first coil 706 may be selectively electrically disconnected from the first circuitry. This provides at least the following benefits: one of the first and second circuitries are not loaded by the other of the first and second circuitries when not in use, and since the first coil 706 and the second coil 708 may be designed separately, fewer compromises may be made in the design of either the first coil 706 or the second coil 708.

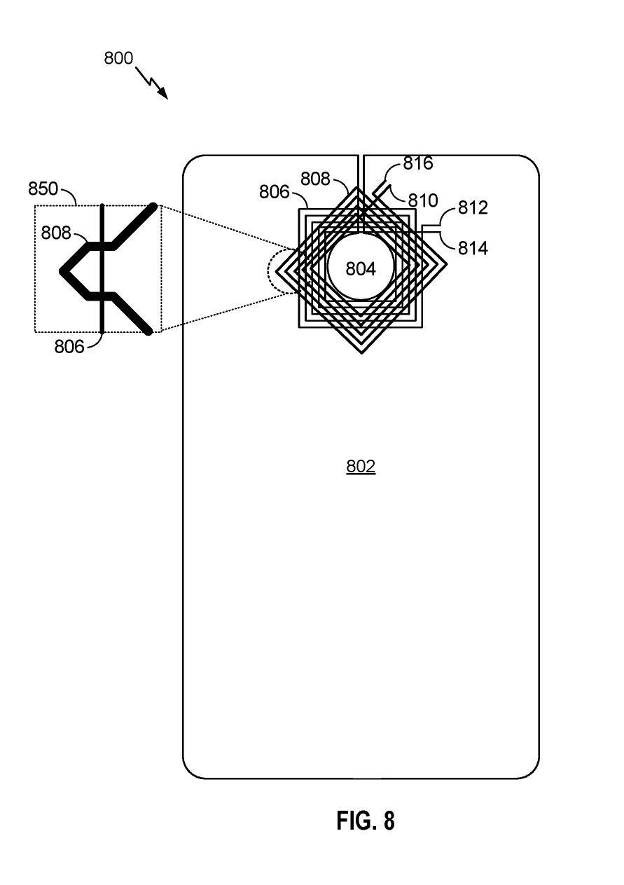

FIG. 8 illustrates a top view 800 of another metallic cover 802 for an electronic device, in accordance with some implementations. The metallic cover 802 is shown as having a removed portion 804, which may be a camera lens port or any other gap. The metallic cover 802 is also shown having a first coil 806 and a second coil 808. The first coil 806 is substantially wound around the removed portion 804 of the metallic cover 802. The second coil 808 is also substantially wound around the removed portion 804 of the metallic cover 802. Rather than being interleaved with one another, the first coil 806 and the second coil 808 are implemented on separate planes, or on interleaved planes such that the conductors of each of the first coil 806 and the second coil 808 are wound over and then under one another, and rotated (e.g., by 45°) with respect to one another. Rotating the first coil 806 with respect to the second coil 808 ensures that the conductors of each coil do not extend substantially parallel to one another, and therefore decreases the induced interference from one coil to the other. The first coil 806 has a first port 812 and a second port 814. Likewise, the second coil 808 has a third port 816 and a fourth port 810. The first port 812 and the second port 814 may be selectively connected to a first circuitry (not shown) (e.g., a wireless power receive circuitry for a wireless power receive coil or a communication circuitry for a communications coil). Likewise, the third port 816 and the fourth port 810 may be selectively connected to a second circuitry (not shown) (e.g., a communication circuitry for a communications coil or a wireless power receive circuitry for a wireless power receive coil). In some implementations, when the first coil 806 and its associated first circuitry are active, the second coil 808 may be selectively electrically disconnected from the second circuitry. Contrarily, when the second coil 808 and its associated second circuitry are active, the first coil 806 may be selectively electrically disconnected from the first circuitry. This provides at least the following benefits: one of the first and second circuitries are not loaded by the other of the first and second circuitries when not in use, since the first coil 806 and the second coil 807 are not interleaved, they may both be as close to the removed portion 804 to improve the coupling via the metal aperture 804 to the external coupled device circuits, and since the first coil 806 and the second coil 808 may be designed separately, fewer compromises may be made in the design of either the first coil 806 or the second coil 808.

In some implementations, as shown by call out 850, the traces of the first coil 806 and the traces of the second coil 808 may be disposed such that they cross one another at right angles (e.g., substantially at 90°). This ensures that interference or noise caused by the electromagnetic fields generated by currents circulating in the coils is reduced. This may be achieved by adjusting the angle of extension of one coil at the intercept point with the other coil and then adjusting the angle of extension back to its original direction after crossing the other coil. In some other implementations, the corners of one coil may be adjusted such that they are as far as possible from an adjacent trace of the other coil. This may require the corners of the one coil to be disposed substantially midway between two adjacent traces of the other coil.

In each of the implementations of FIGS. 4-8, the first coil and the second coil may be arranged such that the traces are disposed closer to the removed portion of the metallic cover than would be possible with designs other than those shown. This may provide for increased coupling between each of the first coil and the second coil and at least one coil of another device. For example, in FIGS. 4 and 7 the first and second coil are interleaved such that the average distance of the traces from the removed portion are reduced. In FIG. 5, the first coil and the second coil are wound from the same trace such that they share the innermost portion of the trace, reducing the average distance from the trace to the removed portion. In FIG. 8, the first coil and the second coil are rotated with respect to one another such that the traces of each coil may have substantially the same average distance from the removed portion without being disposed on exactly the same locations.

Referring to FIG. 4, but equally applicable to any of FIGS. 5-8, as one non-limiting example of the operation, an externally generated magnetic field generated by a transmitter 104 (FIG. 1) may induce eddy currents in the metal cover 402. The eddy currents may be somewhat more concentrated near and/or around the removed portion 404 and generate a magnetic field for coupling to the first coil 406 or second coil 408 when configured for wireless power transfer. The eddy currents may be concentrated in part because the slot connecting the removed portion 404 to the edge of the metal cover 402 disallows the eddy currents from flowing across the slot, requiring them to flow around the slot and the removed portion 404. Similarly the first coil 406 or second coil 408 when configured for communications may couple to a field to transmit or receive data via a modulated field and/or signal. However, for other implementations with different materials, the first coil 406 or the second coil 408 may directly couple to an externally generated field for wireless power transfer, for example, or a combination of wireless coupling may be possible.

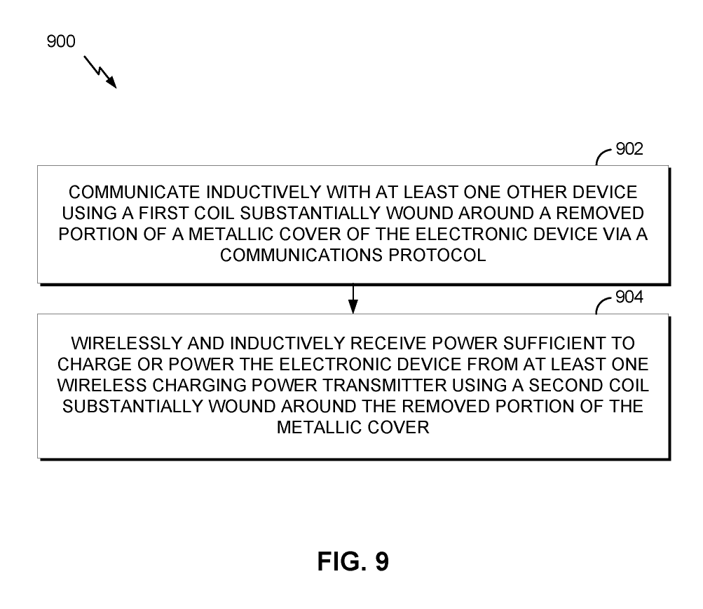

FIG. 9 is a flowchart 900 for a method for wirelessly coupling an electronic device with other devices, in accordance with some implementations. In some implementations, one or more of the operations in flowchart 900 may be performed by, or in connection with, a processor, although those having ordinary skill in the art will appreciate that other components may be used to implement one or more of the steps described herein. Although blocks may be described as occurring in a certain order, the blocks can be reordered, blocks can be omitted, and/or additional blocks can be added.

The flowchart 900 may begin with block 902, which includes communicating inductively with at least one other device using a first coil substantially wound around a removed portion of a metallic cover of the electronic device via a communications protocol. For example, as previously described in connection with any of FIGS. 4-8, the first coil 406, 506, 706, 806 is substantially wound around the removed portion 404, 504, 704, 804 of the metallic cover 402, 502, 702, 802 of an electronic device and is configured to communicate with at least one other device via a communications protocol, such as NFC, 802.11 or any other known communication protocol. In some implementations, the first coil 406, 506, 706, 806 may also be known as, or comprise at least a portion of “means for communicating inductively with at least one other device via a communications protocol.”

The flowchart 900 may continue with block 904, which includes wirelessly and inductively receiving power sufficient to charge or power the electronic device from at least one wireless charging power transmitter using a second coil substantially wound around the removed portion of the metallic cover. For example, as previously described in connection with any of FIGS. 4-8, the second coil 408, 508, 708, 808 is substantially wound around the removed portion 404, 504, 704, 804 of the metallic cover 402, 502, 702, 802 and is configured to wirelessly receive power sufficient to charge or power the electronic device from at least one wireless charging power transmitter. In some implementations, the second coil 408, 508, 708, 808 may also be known as, or comprise at least a portion of “means for wirelessly and inductively receiving power sufficient to charge or power the apparatus from at least one wireless charging power transmitter.”

In some implementations, the first coil 406, 506 and the second coil 408, 508 share a common port 410, 510. In some implementations, the first coil 406, 706 and the second coil 408, 708 are wound such that traces of the first coil 406, 706 are interleaved with traces of the second coil 408, 708. In some implementations, one end of the second coil 408 is electrically connected at a position along the first coil 406. In some implementations, a trace forming the first coil 706, 806 is mutually exclusive of a trace forming the second coil 708, 808. In such implementations, the first coil 706, 806 comprises a first port 712, 812 and a second port 714, 814 and the second coil 708, 808 comprises a third port 716, 816 and a fourth port 710, 810. In some implementations, a trace of the first coil 506 comprises the second coil 508 and a segment of the trace not common to the first coil 506 and the second coil 508. In such implementations, a switching circuitry 602 is configured to electrically connect the segment of the trace not common to the first coil 506 and the second coil 508 to the second coil 508. In some implementations, the first coil 806 overlaps the second coil 808 and the first coil 806 is rotated with respect to the second coil 808 such that a trace of the first coil 806 does not extend parallel to a trace of the second coil 808. In such implementations, the trace of the first coil 806 crosses the trace of the second coil 808 at a substantially 90° angle.

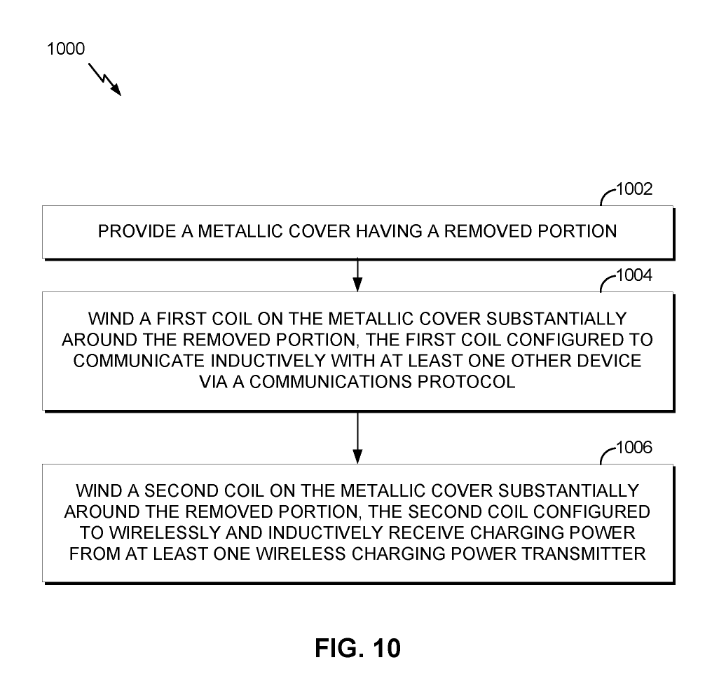

FIG. 10 is a flowchart 1000 for a method for manufacturing an electronic device for wirelessly coupling with other devices, in accordance with some implementations. In some implementations, one or more of the operations in flowchart 1000 may be performed by a manufacturer of the electronic devices described in connection with FIGS. 4-8, which could include a human worker, a machine, or both. Although blocks may be described as occurring in a certain order, the blocks can be reordered, blocks can be omitted, and/or additional blocks can be added.

The flowchart 1000 may begin with block 1002, which includes providing a metallic cover having a removed portion. For example, as previously described in connection with any of FIGS. 4-8, the metallic cover 402, 502, 702, 802 having the removed portion 404, 504, 704, 804 may be provided.

The flowchart 1000 may continue with block 1004, which includes winding a first coil on the metallic cover substantially around the removed portion, the first coil configured to communicate inductively with at least one other device via a communications protocol. For example, as previously described in connection with any of FIGS. 4-8, a first coil 406, 506, 606, 706, 806 may be wound on the metallic cover 402, 502, 702, 802, substantially wound around the removed portion 404, 504, 704, 804, and configured to communicate with at least one other device via a communications protocol (e.g., NFC).

The flowchart 1000 may continue with block 1006, which includes winding a second coil on the metallic cover substantially around the removed portion, the second coil configured to wirelessly and inductively receive charging power from at least one wireless charging power transmitter. For example, as previously described in connection with any of FIGS. 4-8, a second coil 408, 508, 608, 708, 808 may be wound on the metallic cover 402, 502, 702, 802 and substantially wound around the removed portion 404, 504, 704, 804. The second coil 408, 508, 608, 708, 808 is configured to wirelessly receive charging power from at least one wireless charging power transmitter.

In some implementations, the first coil 406, 506 and the second coil 408, 508 share a common port 410, 510. In some implementations, the flowchart 1000 may further include winding the first coil 406, 706 and the second coil 408, 708 such that traces of the first coil 406, 706 are interleaved with traces of the second coil 408, 708. In some implementations, the flowchart 1000 further includes electrically connecting one end of the second coil 408 at a position along the first coil 406. In some implementations, a trace forming the first coil 706, 806 is mutually exclusive of a trace forming the second coil 708, 808. In such implementations, the first coil 706, 806 comprises a first port 712, 812 and a second port 714, 814 and the second coil 708, 808 comprises a third port 716, 816 and a fourth port 710, 810. In some implementations, a trace of the first coil 506 comprises the second coil 508 and a segment of the trace not common to the first coil 506 and the second coil 508. In such implementations, a switching circuitry 602 is configured to electrically connect the segment of the trace not common to the first coil 506 and the second coil 508 to the second coil 508. In some implementations, the first coil 806 overlaps the second coil 808 and the first coil 806 is rotated with respect to the second coil 808 such that a trace of the first coil 806 does not extend parallel to a trace of the second coil 808. In such implementations, the trace of the first coil 806 crosses the trace of the second coil 808 at a substantially 90° angle.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

What is claimed is:

1. An apparatus for wirelessly coupling with other devices, the apparatus comprising:
a metallic cover having a removed portion;
a first coil substantially wound around the removed portion of the metallic cover and configured to communicate with at least one other device via a communications protocol; and
a second coil substantially wound around the removed portion of the metallic cover and configured to wirelessly and inductively receive charging power sufficient to charge or power the apparatus from at least one wireless charging power transmitter.

2. The apparatus of claim 1, wherein a slot extends from an edge of the metallic cover to the removed portion.

3. The apparatus of claim 1, wherein the first coil and the second coil share a common port.

4. The apparatus of claim 1, wherein the first coil and the second coil are wound such that traces of the first coil are interleaved with traces of the second coil.

5. The apparatus of claim 4, wherein one end of the second coil is electrically connected at a position along the first coil.

6. The apparatus of claim 4, wherein a trace forming the first coil is mutually exclusive of a trace forming the second coil, the first coil comprising a first port and a second port, and the second coil comprising a third port and a fourth port.

7. The apparatus of claim 1, wherein a trace of the first coil comprises the second coil and a segment of the trace not common to the first coil and the second coil.

8. The apparatus of claim 7, further comprising a switch configured to electrically connect the segment of the trace not common to the first coil and the second coil to the second coil.

9. The apparatus of claim 1, wherein the first coil overlaps the second coil and the first coil is rotated with respect to the second coil.

10. The apparatus of claim 1, wherein a trace of the first coil does not extend parallel to a trace of the second coil.

11. A method for wirelessly coupling an electronic device with other devices, comprising:
communicating with at least one other device using a first coil substantially wound around a removed portion of a metallic cover of the electronic device via a communications protocol; and
wirelessly and inductively receiving power sufficient to charge or power the electronic device from at least one wireless charging power transmitter using a second coil substantially wound around the removed portion of the metallic cover.

12. The method of claim 11, wherein the first coil and the second coil share a common port.

13. The method of claim 11, wherein the first coil and the second coil are wound such that traces of the first coil are interleaved with traces of the second coil.

14. The method of claim 13, wherein one end of the second coil is electrically connected at a position along the first coil.

15. The method of claim 13, wherein a trace forming the first coil is mutually exclusive of a trace forming the second coil, the first coil comprising a first port and a second port, and the second coil comprising a third port and a fourth port.

16. The method of claim 11, wherein a trace of the first coil comprises the second coil and a segment of the trace not common to the first coil and the second coil.

17. The method of claim 16, further comprising electrically connecting the segment of the trace not common to the first coil and the second coil to the second coil.

18. The method of claim 11, wherein the first coil overlaps the second coil and the first coil is rotated with respect to the second coil.

19. The method of claim 18, wherein a trace of the first coil does not extend parallel to a trace of the second coil.

20. A method for manufacturing an electronic device for wirelessly coupling with other devices, comprising:
providing a metallic cover having a removed portion;
winding a first coil on the metallic cover substantially around the removed portion, the first coil configured to communicate with at least one other device via a communications protocol; and
winding a second coil on the metallic cover substantially around the removed portion, the second coil configured to wirelessly and inductively receive charging power sufficient to charge or power the electronic device from at least one wireless charging power transmitter.

21. The method of claim 20, wherein the first coil and the second coil share a common port.

22. The method of claim 20, further comprising winding the first coil and the second coil such that traces of the first coil are interleaved with traces of the second coil.

23. The method of claim 22, further comprising electrically connecting one end of the second coil at a position along the first coil.

24. The method of claim 22, wherein a trace forming the first coil is mutually exclusive of a trace forming the second coil, the first coil comprising a first port and a second port, and the second coil comprising a third port and a fourth port.

25. The method of claim 20, wherein a trace of the first coil comprises the second coil and a segment of the trace not common to the first coil and the second coil.

26. The method of claim 25, further comprising electrically connecting the segment of the trace not common to the first coil and the second coil to the second coil using a switch.

27. The method of claim 20, wherein the first coil overlaps the second coil and the first coil is rotated with respect to the second coil.

28. An apparatus for wirelessly coupling with other devices, comprising:
a metallic cover comprising a removed portion;
means for communicating with at least one other device via a communications protocol, the means for communicating substantially wound around the removed portion of the metallic cover; and
means for wirelessly and inductively receiving power sufficient to charge or power the apparatus from at least one wireless charging power transmitter, the means for wirelessly receiving power substantially wound around the removed portion of the metallic cover.

29. The apparatus of claim 28, wherein the means for communicating and the means for wirelessly receiving power are wound such that traces of the means for communicating are interleaved with traces of the means for wirelessly receiving power.

30. The apparatus of claim 28, wherein the means for communicating overlaps the means for wirelessly receiving power and the means for communicating is rotated with respect to the means for wirelessly receiving power such that a trace of the means for communicating does not extend parallel to a trace of the means for wirelessly receiving power.
